(19) United States
(12) Patent Application Publication
(10) Pub. No.: US 2021/0114743 A1
(43) Pub. Date: Apr. 22, 2021

(54) Clamping Device

(71) Applicants: TRAVIS BOSWELL, Mechanicsville, MD (US); Adam Gregory Konneker, Owens Crossroads, AL (US)

(72) Inventors: TRAVIS BOSWELL, Mechanicsville, MD (US); Adam Gregory Konneker, Owens Crossroads, AL (US)

(73) Assignee: United States of America as represented by the Secretary of the Navy, Patuxent River, MD (US)

(21) Appl. No.: 16/658,722

(22) Filed: Oct. 21, 2019

(51) Int. Cl. B64D 41/00; F16L 3/10; F16B 2/06

(52) U.S. Cl. CPC B64D 41/00; B64D 2221/00; F16B 2/065; F16L 3/10

(57) ABSTRACT

A clamping device includes a length, a first member, a second member, and a tightening screw. The first member has a plurality of slots, a ball end, and an axis. The slots are perpendicularly oriented to the axis of the first member. The first member communicates with the second member such that the length of the clamping device can be adjusted. The second member has a first portion with a stop end and a second portion with a pivot end that fits into any one of the plurality of slots. The tightening screw attaches the first member to the second member. The first portion and the second portion each have a tightening screw slot for accepting the tightening screw and allowing the clamping device to be adjusted such that it allows clamping onto an existing aircraft structure via the ball end, the stop end, and the finger.

### STATEMENT OF GOVERNMENT INTEREST

The invention described herein may be manufactured and used by or for the Government of the United States of America for governmental purposes without payment of any royalties thereon or therefor.

### BACKGROUND

Historically, cables must be routed in through existing routes and Adel clamping locations on aircraft. An Adel clamp may be defined, but without limitation, as a metal band, constructed from aluminum, corrosion-resistant steel, and low-carbon steel, covered by a rubber lining or cushion, made from silicone. This process requires longer installation schedules. New cable routes require drilling holes into aircraft structure or mounting a click-bond to the aircraft via an epoxy bonding process. Due to the structural integrity of the aircraft ribs, many of these structures are prohibited from modification, restricting the options for routing and drastically increasing the time needed for installation.

### SUMMARY

The present invention is directed to the clamping device with the needs enumerated above and below.

The present invention is directed to a clamping device for securing components to aircraft structures. The clamping device comprises of a length, a first member, a second member, and a tightening screw. The first member has a plurality of adjustment slots, a ball end, a slot end and an axis. The adjustment slots are perpendicularly oriented to the axis of the first member, and are disposed at the slot end. The second member has a first portion and a second portion. The first member communicates with the second member such that the length of the clamping device can be lengthened or shortened. The first portion has a stop end and a finger perpendicularly disposed to each other. The second portion has a pivot end that fits into any one of the plurality of adjustment slots. The tightening screw is for attaching the first member to the second member. The first member and the second member have a tightening screw slot for accepting the tightening screw and allowing the clamping device to be adjusted such that it allows the clamping onto an existing aircraft structure via the ball end, the stop end, and the finger.

It is a feature of the present invention to provide a clamping device that is adjustable and can be mounted to different aircraft structures with variation in width and thickness.

It is a feature of the present invention to provide a clamping device that allows for mounting cable and/or other items to an aircraft without modification of the aircraft structure or use of any adhesion process.

It is a feature of the present invention to provide a clamping device that provides a route for cabling on aircraft that is otherwise non-existent.

It is a feature of the present invention to provide a clamping device that is a universal design that can be used on multiple aircraft structures, and can be attached to the airframe using only simple tools, such as, but without limitation, a screwdriver, wrench, or socket.

### DRAWINGS

These and other features, aspects and advantages of the present invention will become better understood with reference to the following description and appended claims, and accompanying drawings wherein:

FIG. 1 is a side perspective view of an embodiment of the clamping device;

FIG. 2 is side view of the clamping device;

FIG. 3 is a top and side view of the first member; and,

FIG. 4 is a side and top view of the second member.

### DESCRIPTION

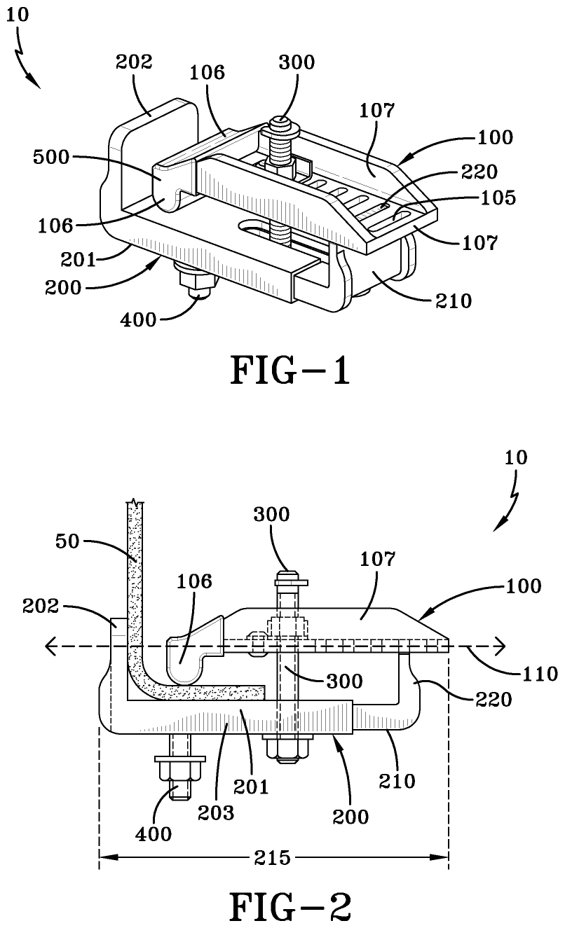

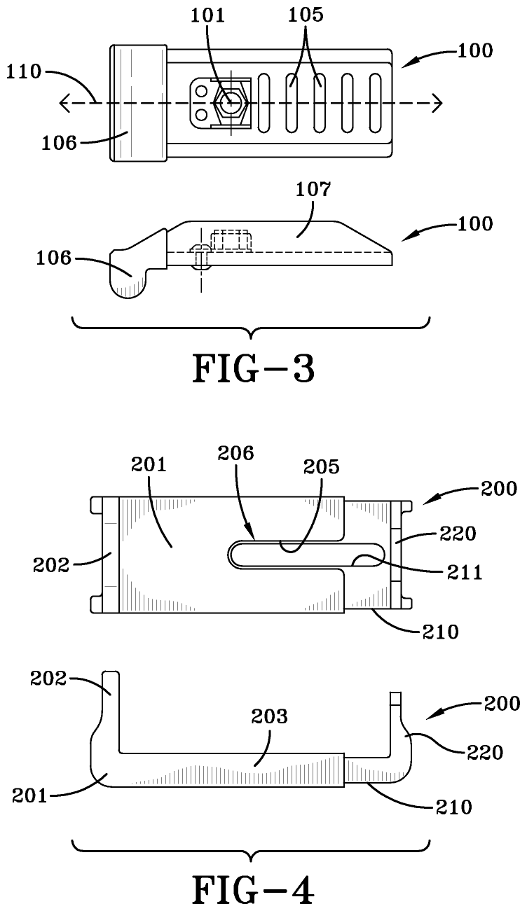

The preferred embodiments of the present invention are illustrated by way of example below and in FIGS. 1- 4. As shown in FIGS. 1 and 2, a clamping device 10 for securing components to an aircraft structure includes a length 215, first member 100, a second member 200, and a tightening screw 300. As shown in FIGS. 1, 2, and 3, the first member 100 has a plurality of adjustment slots 105, a ball end 106, a slot end 107, and an axis 110. The adjustment slots 105 are substantially perpendicularly oriented to the axis 110 of the first member 100. As shown in FIGS. 1, 2, and 4, the second member 200 has a first portion 201, a second portion 210, and a second member slot 205 extending through the first portion 201 and the second portion 210 (each portion having a corresponding tightening screw slot 206, 211, both of which create the second member slot 205). As shown in FIG. 2, the first member 100 communicates with the second member 200 such that the length 215 of the clamping device 10 can be lengthened or shortened. The first portion 201 of the second member 200 has a stop end 202 and a finger 203, which are perpendicularly orientated to each other. The second portion 210 also has a pivot end 220 located on the opposite end of the stop end 202. The pivot end 220 corresponds and fits into any one of the plurality of adjustment slots 105. The tightening screw 300 is for attaching the first member 100 to the second member 200 via the second member slot 205 and a first member aperture 101 disposed on the first member 100. The second member slot 205 is comprised of a first member tightening screw slot 206 and a second member tightening screw slot 211 for accepting the tightening screw 300, and allowing the clamping device 10 to be adjusted, such that, as shown in FIG. 2, the clamping device 10 can be clamped onto an existing aircraft structure 50 via the ball end 106, the stop end 202, and the finger 203, and allowing adjustment of the length 215 of the clamping device 10.

In the description of the present invention, the invention will be discussed in a military aircraft environment; however, this invention can be utilized for any type of application that requires use of a clamping device.

In operation, the tightening screw 300 is loosened until the first member 100 can move freely and independently of the second member 200. In one of the embodiments, the second member 200 is positioned on the frontside of an aircraft structure 50, and one of the adjustment slots 105 of the first member 100 is positioned onto the pivot end 210 of the second member 200 to achieve desired length 215 of the clamping device 10. The tightening screw 300 is tightened so that the first member 100 and the second member 200 are secured to each other, and the clamping device 10 is tightly secured to the aircraft structure 50.

In one of the embodiments of the invention, the clamping device 10 includes an accessory attachment 400 (shown in FIGS. 1 and 2), that can allow the clamping device 10 to accept, but without limitation, an Adel clamp, a mount ball, a camera, or another small device. In the preferred embodiment, the accessory attachment 400 is attached to the second member 200, preferably disposed at the first portion 201. The accessory attachment 400 can be, but without limitation, a threaded hole with a self-locking Helicoil, a threaded stud, or any type of attachment device that is practicable. Additionally, as shown in FIG. 1, the first member 100 and the second member 200 may be covered with a protective cover 500, to prevent damage and inhibit slipping. The protective coating 500 may be, but without limitation, a rubber coating, a polymer, an epoxy, or any type of coating practicable. The first member 100 and the second member 200 may be anodized and color-coded for identification purposes.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A clamping device for securing components to aircraft structures, the clamping device having a length, the clamping device comprising:
a first member having a plurality of adjustment slots, a ball end, a slot end, and an axis, the adjustment slots perpendicularly oriented to the axis of the first member and disposed at the slot end;
a second member having a first portion, a second portion, the first member communicating with the second member such that the length of the clamping device can be lengthened or shortened, the first portion having a stop end and a finger, the stop end perpendicularly disposed to the finger, the second portion having a pivot end that fits into any one of the plurality of adjustment slots;
a tightening screw for attaching the first member to the second member, the first portion and the second portion each having a corresponding tightening screw slot for accepting the tightening screw and allowing the clamping device to be adjusted such that it allows clamping onto an existing aircraft structure via the ball end, the stop end, and the finger.

2. The clamping device of claim 1 wherein the first member and second member includes a coating for preventing surface damage to the aircraft structure.
